(19) United States
(12) Patent Application Publication
(10) Pub. No.: US 2015/0177716 A1
(43) Pub. Date: Jun. 25, 2015

(54) OCCUPANCY DETECTION

(71) Applicants: Nick Hyman, Los Alto Hills, CA (US); Bo E. Ericsson, Los Gatos, CA (US); Tanuj Mohan, Mountain View, CA (US)

(72) Inventors: Nick Hyman, Los Alto Hills, CA (US); Bo E. Ericsson, Los Gatos, CA (US); Tanuj Mohan, Mountain View, CA (US)

(73) Assignee: enLighted, Inc., Sunnyvale, CA (US)

(21) Appl. No.: 14/135,814

(22) Filed: Dec. 20, 2013

(51) Int. Cl. G05B 15/02; G05B 1/03

(52) U.S. Cl. CPC G05B 15/02; G05B 1/03

(57) ABSTRACT

Apparatuses, methods, apparatuses and systems for occupancy detection are disclosed. One occupancy detection system includes a plurality of sensors located within an area. Communication links are established between each of the sensors and a controller. The controller is operative to receive sense data from the plurality of sensors, group the data according to identified groupings of the plurality of sensors, and sense occupancy within at least a portion of the area based on data analytics processing of one or more of the groups of sensed data.

### FIELD OF THE EMBODIMENTS

The described embodiments relate generally to control systems. More particularly, the described embodiments relate to methods, apparatuses and systems for occupancy detection.

### BACKGROUND

Intelligent lighting and environmental control systems reduce power consumption of lighting and environmental control while improving the experience of occupants of structures that utilize the lighting and environmental control systems. A factor utilized in controlling the systems is determination of occupancy. Further, the number of occupants can be used for controlling the systems.

It is desirable to have a method, system and apparatus for occupancy detection of an area.

### SUMMARY

One embodiment includes an occupancy detection system. The occupancy detection system includes a plurality of sensors located within an area. Communication links are established between each of the sensors and a controller. The controller is operative to receive sense data from the plurality of sensors, group the data according to identified groupings of the plurality of sensors, and sense occupancy within at least a portion of the area based on data analytics processing of one or more of the groups of sensed data.

Another embodiment includes a method of detecting occupancy. The method includes receiving motion sense data from a plurality of motion sensors, grouping the motion sensing data according to one or more identified rooms, and performing data analytics processing on the motion sensing data to determine a number of occupants within the one or more identified rooms, and a level of certainty of the number of occupants.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows an area that includes multiple rooms, wherein sensors within each of the multiple rooms and a controller are utilized for detecting occupancy.

FIG. 2 is a flow chart that includes steps of a method of occupancy detection, according to an embodiment.

FIG. 3 is a flow chart that includes steps of a method of occupancy detection, according to another embodiment.

FIG. 4 is a flow chart that includes steps of a method of occupancy detection, according to another embodiment.

FIG. 5 shows a sensor and associated lighting control, according to an embodiment.

FIG. 6 is a plot that shows sensed signal samples of a plurality of sensors over a sampling interval, according to an embodiment.

FIG. 7 is a plot that shows weighting applied to the sensed signal samples of FIG. 6, according to an embodiment.

FIG. 8 is a plot that shows the sensed signal samples of FIG. 6 where the weighting of FIG. 7 has been applied to the sensed signal samples, according to an embodiment.

FIG. 9 shows a plot of weighted averages of the weighted sensed signal samples of FIG. 8 for an exemplary room, for multiple trials, according to an embodiment.

FIG. 10 is a table that shows estimated numbers of occupants while utilizing several different motion sampling criteria, according to an embodiment.

### DETAILED DESCRIPTION

As shown in the drawings, the described embodiments provide methods, apparatuses, and systems for occupancy detection. Additionally or alternatively, the described embodiments provide detection or sensing of motion within an area, or across areas. Data analysis performed on motion sensed by multiple motion sensors of one or more areas can be used to estimate a number of occupants within the one or more areas. For an embodiment, the multiple sensors are grouped, for example, according to identified rooms of the one or more areas.

While the described embodiments are primarily focused on occupancy detection through motion detection, it is to be understood that the presented data analytics can be adapted to detecting other conditions of, for example, a room or area. For example, data analytics on the sensor information of a plurality of temperature sensors within the room or area can be used to track, for example, a rate of temperature change through the room or area. This information can be used to determine, for example, are flow through the room or area. Analytics of the sensed temperature information can be used for HVAC (heating, ventilation, and air conditioning), and space (vent locations and air speed) optimizations. Further, for example, data analytics on sensed data of ambient light sensors can be used for determining the location, orientation, and/or direction of windows of an area. Further, the data analytics can be used to determine the orientation of the area or room itself.

At least some embodiments report the start and end times of occupancy fir each sensor grouping along with the degree of occupancy. The real time data makes it possible to check the status of a remote room without requiring a user to travel to the remote room. If a room was scheduled to be occupied and is found to be vacant, the described embodiments provide a reliable way of updating a status of the remote room.

The aggregation of the sensor data over time provides valuable insights for parties interested in optimizing space utilization and planning the construction of future spaces. This aggregation can be used to detect abnormalities in real time operation of, for example, an office building.

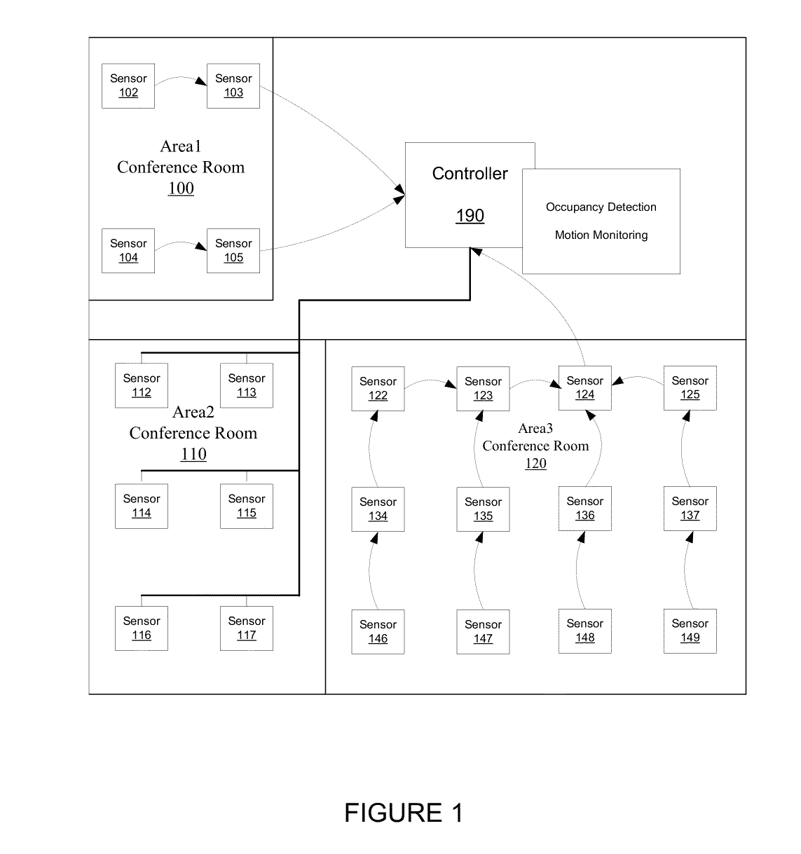

FIG. 1 shows an area that includes multiple rooms, wherein sensors within each of the multiple rooms and a controller are utilized for detecting occupancy, according to an embodiment. As shown, occupancy can be detected in an area, such as, a first area 100, a second area 110 and/or a third area 120. The exemplary first area 100 includes sensors 102, 103, 104, 104. The exemplary second area 110 includes sensors 112-117. The exemplary third area 120 includes sensors 122-125, 134-137, 146-149. As shown, a controller 190 receives sensor data from the listed sensors.

For an embodiment, communication links are established between each of the sensors and the controller 190. For an embodiment, the sensors are directly linked to the controller 190. For another embodiment, at least some of the sensors are linked to the controller 190 through other sensors. For an embodiment, the sensors form a wireless mesh network that operates to wirelessly connect (link) each of the sensors to the controller. For an embodiment, one or more of the sensors includes a controller, and a plurality of the sensors is linked to the controller. For an embodiment, one or more of the sensors include motion sensors. For an embodiment, the controller is centrally located, for another embodiment, the controller and associated processing is distributed, for example, across the controllers of multiple sensors.

Regardless of the location or configuration of the controller 190, for an embodiment, the controller 190 is operative to receive sense data from the plurality of sensors, group the data according to identified groupings of the plurality of sensors, and sense occupancy within at least a portion of the area based on data analytics processing of one or more of the groups of sensed data.

For an embodiment, the identified grouping correspond to identified rooms, such as, the exemplary first area 100 (conference room) which includes sensors 102, 103, 104, 104, the exemplary second area 110 (conference room) that includes sensors 112-117, and the exemplary third area 120 (conference room) includes sensors 122-125, 134-137, 146-149.

For an embodiment, based on the data analytics, the controller is operative to sense numbers of occupants within one or more of the groups. For an embodiment, the controller is additionally or alternatively operative to sense motion of the occupants within one or more of the groups based on the data analytics processing of the groups of sensed data, and/or sense motion of the occupants across a plurality of the groups based on the data analytics processing of the groups of sensed data. For an embodiment, the data analytics processing includes pattern recognition processing.

For at least some embodiments, at least a portion of the plurality of sensors includes motion sensors. Further, for an embodiment, sensing the numbers of occupants within one or more of the groups based on the data analytics processing of the groups of sensed data includes the controller being operative to group motion sensing data according to one or more identified rooms within the area, perform the data analytics processing once every sampling period, and perform the data analytics processing on the motion sensing data to determine a number of occupants within the one or more identified rooms, and a level of certainty of the number of occupants.

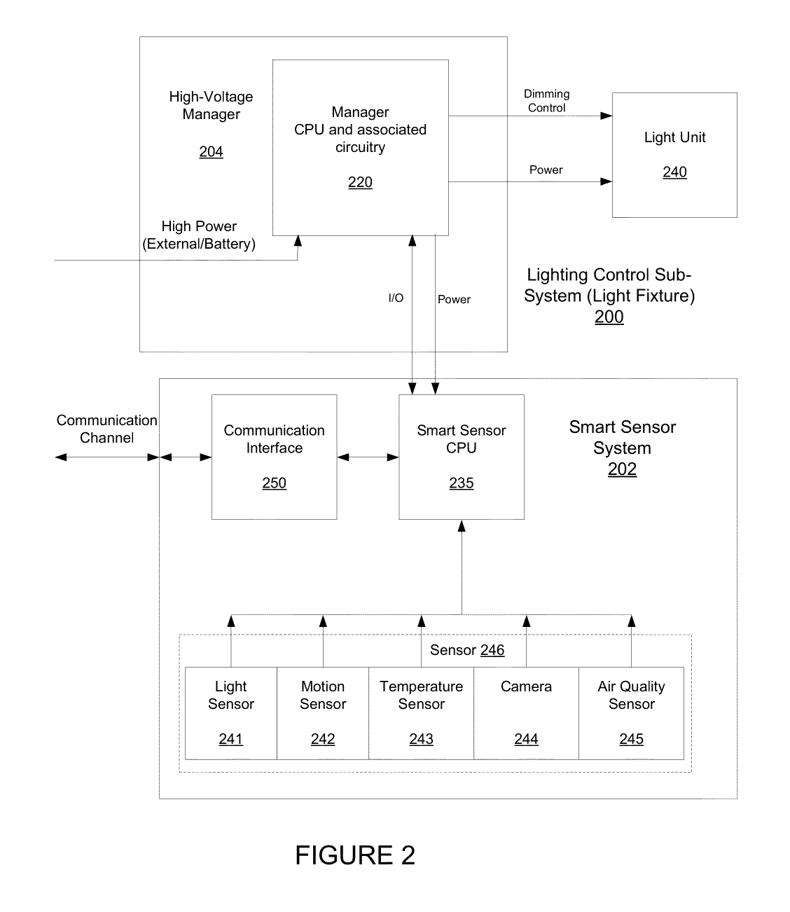

FIG. 2 shows sensor and associated lighting control, according to an embodiment. A sensor and associated lighting control system 200 includes a smart sensor system 202 that is interfaced with a high-voltage manager 204, which is interfaced with a luminaire 240. The sensor and associated lighting control of FIG. 2 is one exemplary embodiment of the sensors utilized for occupancy detection. Many different sensor embodiments are adapted to utilization of the described embodiments for occupant sensing and motion. For at least some embodiments, sensors that are not directly associated with light control are utilized.

The high-voltage manager 204 includes a controller (manager CPU) 220 that is coupled to the luminaire 240, and to a smart sensor CPU 235 of the smart sensor system 202. As shown, the smart sensor CPU 245 is coupled to a communication interface 250, wherein the communication interface 250 couples the controller to an external device. The smart sensor system 202 additionally includes a sensor 240. As indicated, the sensor 240 can include one or more of a light sensor 241, a motion sensor 242, and temperature sensor 243, and camera 244 and/or an air quality sensor 245. It is to be understood that this is not an exhaustive list of sensors. That is additional or alternate sensors can be utilized for occupancy and motion detection of a structure that utilizes the lighting control sub-system 200. The sensor 240 is coupled to the smart sensor CPU 245, and the sensor 240 generates a sensed input. For at least one embodiment, at least one of the sensors is utilized for communication with the user device.

For an embodiment, the temperature sensor 243 is utilized for occupancy detection. For an embodiment, the temperature sensor 243 is utilized to determine how much and/or how quickly the temperature in the room has increased since the start of, for example, a meeting of occupants. How much the temperate has increased and how quickly the temperature has increased can be correlated with the number of the occupants. All of this is dependent on the dimensions of the room and related to previous occupied periods. For at least some embodiment, estimates and/or knowledge of the number of occupants within a room are used to adjust the HVAC (heating, ventilation and air conditioning) of the room. For an embodiment, the temperature of the room is adjusted based on the estimated number of occupants in the room.

According to at least some embodiments, the controllers (manager CPU 220 and the smart sensor CPU) are operative to control a light output of the luminaire 240 based at least in part on the sensed input, and communicate at least one of state or sensed information to the external device.

For at least some embodiments, the high-voltage manager 204 receives the high-power voltage and generates power control for the luminaire 240, and generates a low-voltage supply for the smart sensor system 202. As suggested, the high-voltage manager 204 and the smart sensor system 202 interact to control a light output of the luminaire 240 based at least in part on the sensed input, and communicate at least one of state or sensed information to the external device. The high-voltage manager 204 and the smart sensor system 202 can also receive state or control information from the external device, which can influence the control of the light output of the luminaire 240. While the manager CPU 220 of the high-voltage manager 204 and the smart sensor CPU 245 of the smart sensor system 202 are shown as separate controllers, it is to be understood that for at least some embodiments the two separate controllers (CPUs) 220, 245 can be implemented as single controller or CPU.

For at least some embodiments, the communication interface 250 provides a wireless link to external devices (for example, the central controller, the user device and/or other lighting sub-systems or devices).

An embodiment of the high-voltage manager 204 of the lighting control sub-system 200 further includes an energy meter (also referred to as a power monitoring unit), which receives the electrical power of the lighting control sub-system 200. The energy meter measures and monitors the power being dissipated by the lighting control sub-system 200. For at least some embodiments, the monitoring of the dissipated power provides for precise monitoring of the dissipated power. Therefore, if the manager CPU 220 receives a demand response (typically, a request from a power company that is received during periods of high power demands) from, for example, a power company, the manager CPU 220 can determine how well the lighting control sub-system 200 is responding to the received demand response. Additionally, or alternatively, the manager CPU 220 can provide indications of how much energy (power) is being used, or saved.

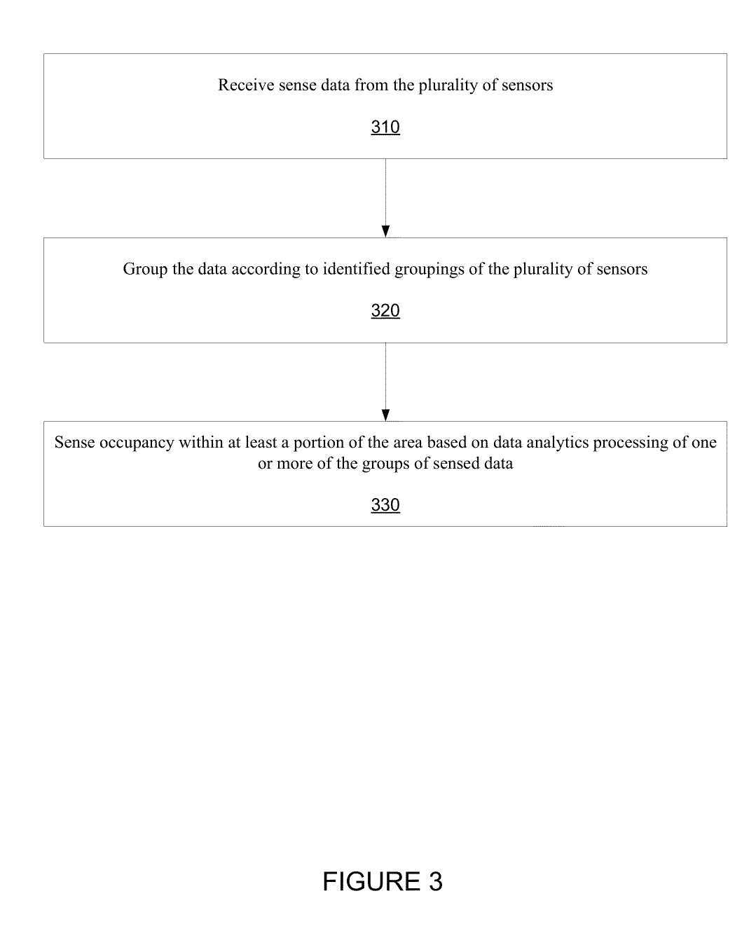

FIG. 3 is a flow chart that includes steps of a method of occupancy detection, according to an embodiment. As previously described, a first step 320 includes receiving sense data from the plurality of sensors, a second step 330 includes grouping the data according to identified groupings of the plurality of sensors, and a third step 330 includes sensing occupancy within at least a portion of the area based on data analytics processing of one or more of the groups of sensed data.

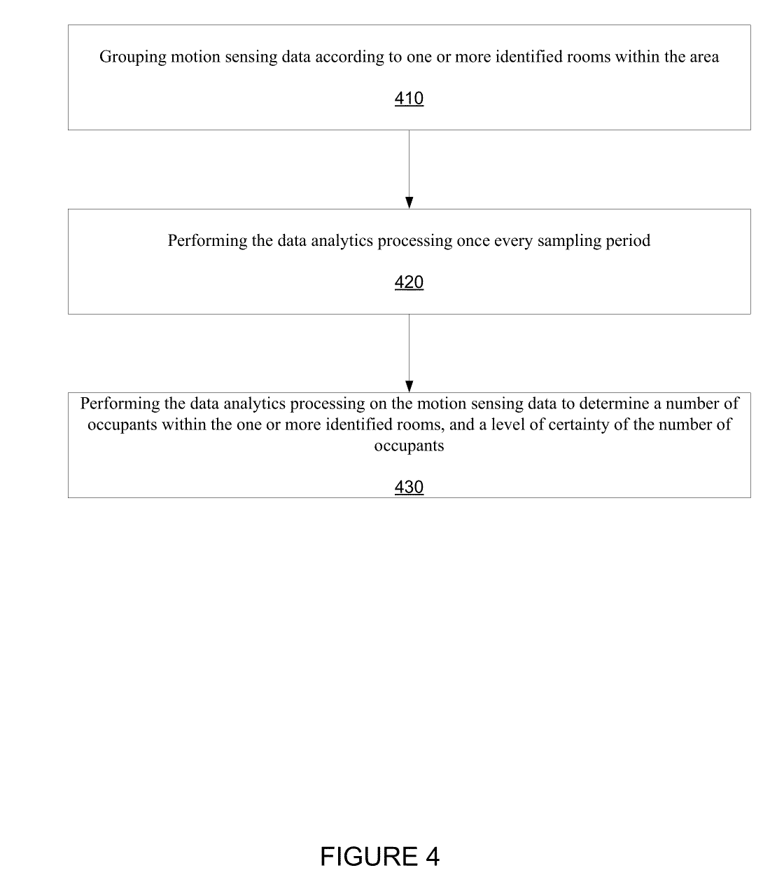

FIG. 4 is a flow chart that includes steps of a method of occupancy detection, according to another embodiment. A first step 410 includes grouping motion sensing data according to one or more identified rooms within the area. A second step 420 includes performing the data analytics processing once every sampling period. A third step 430 includes performing the data analytics processing on the motion sensing data to determine a number of occupants within the one or more identified rooms, and a level of certainty of the number of occupants.

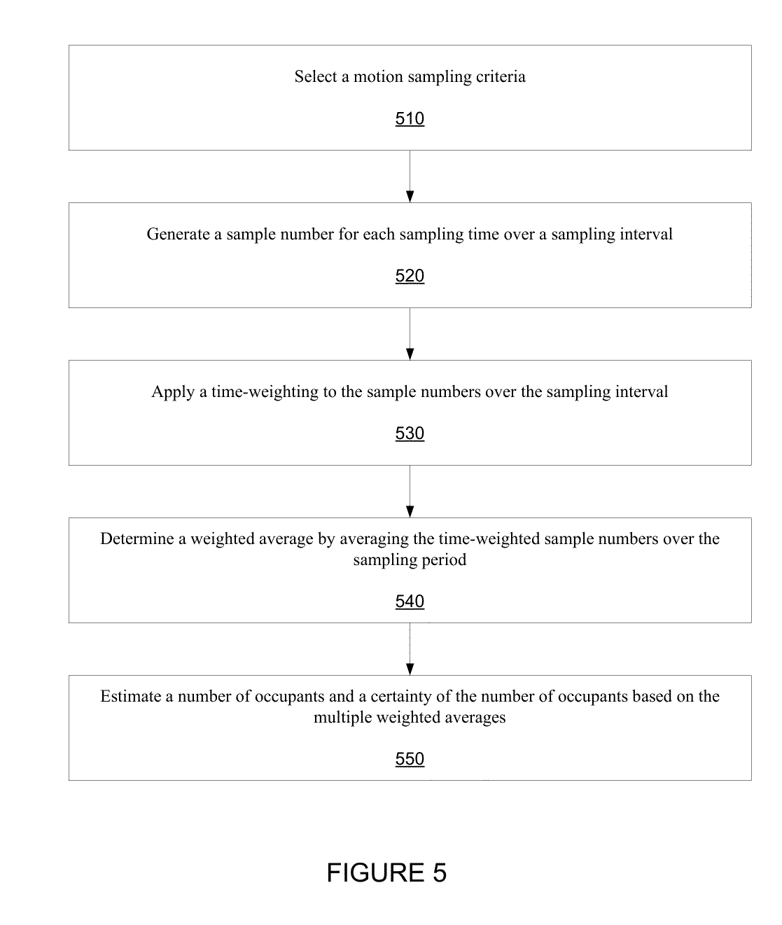

FIG. 5 is a flow chart that includes steps of a method performing the data analytics processing on the motion sensing data to estimate a number of occupants within one or more identified rooms, and a level of certainty of the number of occupants, according to another embodiment. For an area or identified room within a structure, a set number of sensors (such as motion sensors) are located. A first step 510 includes selecting a motion sampling criteria. A first exemplary motion sampling criteria includes generating a sampling number based on sensing how many sensors of a plurality of sensors of the identified room sense motion greater than a threshold at each sampling time of the sampling interval. That is, if a motion sensor generates a sense signal having a magnitude greater than a threshold, it is determined that the motion sensor actually sensed motion. The sample number is a generated number that will be processed for determination of the number of occupants within the identified room. A sampling number is generated at each sampling time over the sampling interval. A second exemplary motion sampling criteria includes generating the sampling number based on sensing a percentage of time that greater than a threshold number of the sensors of the plurality of sensors of the identified room sense motion greater than a threshold at each sampling time of the sampling interval.

For an embodiment, the motion sampling criteria includes determining the sampling number based on sensing how many sensors of a plurality of sensors of the one or more identified rooms sense motion greater than a threshold at each sampling time of the sampling interval, and selecting a quadratic weighting to apply to the sample numbers over the sampling interval.

For an embodiment, the motion sampling criteria includes determining the sampling number based on sensing a percentage of time that greater than a threshold number of the sensors of a plurality of sensors of the one or more identified rooms sense motion greater than a threshold at each sampling time of the sampling interval, and selecting a linear weighting to apply to the sample numbers over the sampling interval.

For an embodiment, the motion sampling criteria includes determining the sampling number based on sensing a percentage of time that less than a threshold number of the sensors of a plurality of sensors of the one or more identified rooms sense motion greater than a threshold at each sampling time of the sampling interval, and selecting a linear weighting to apply to the sample numbers over the sampling interval.

For each motion sampling criteria, at embodiment includes a step 520 that includes generating a sample number for each sampling time over a sampling interval. Next, a step 530 includes applying a time-weighting to the sample numbers over the sampling interval. Next, a step 540 includes determining a weighted average by averaging the time-weighted sample numbers over the sampling period. Finally, a step 550 includes estimating a number of occupants and a certainty of the number of occupants based the weighted average.

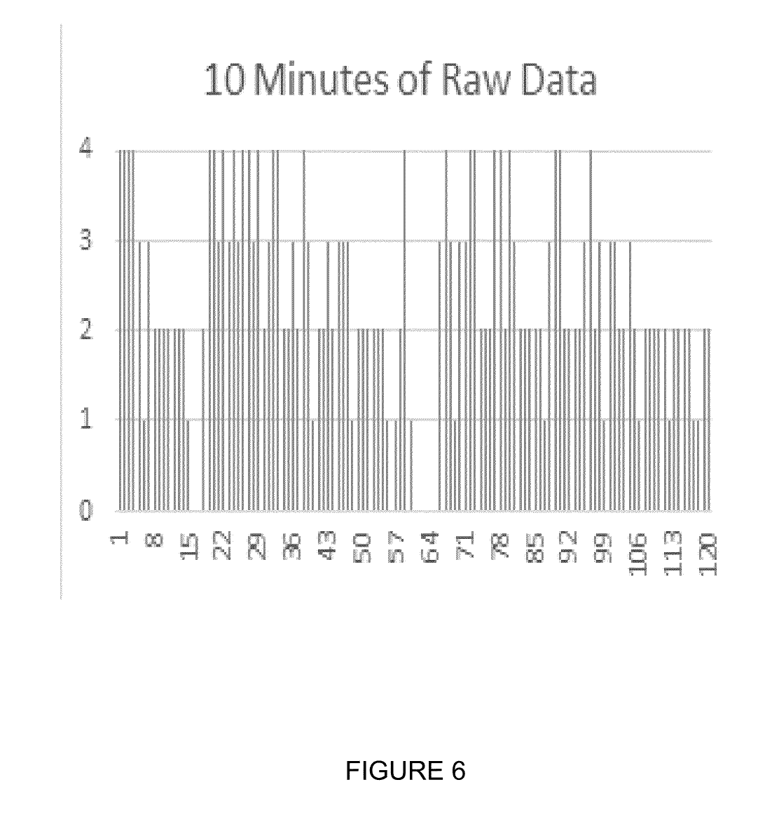

FIG. 6 is a plot that shows sensed signal samples of a plurality of sensors over a sampling interval, according to an embodiment. This exemplary plot shows a 120 sensed signal samples taken over a 10 minute period. For this example, four sensors within a room indicate whether motion is sensed by zero to four of the sensors at each of the samples. As previously described, other embodiments include other (different) motion sampling criteria.

Clearly the sampling period, number of samples, type of sample, and so on can be changed. For example if the meeting within the room has started less than 10 minutes ago, then an embodiment includes only sampling since the start of the meeting. For an embodiment, the sampling rate depends on time of day (activity levels can vary depending on the time of day), type of room (particular rooms may be more active), number of sensors in room, volatility in meeting activity, duration of meeting, desired speed of algorithm, desired certainty in estimates, and/or desired accuracy in the estimate. Generally, the more activity within a room, the more frequently it may be desired to sample activity within the room.

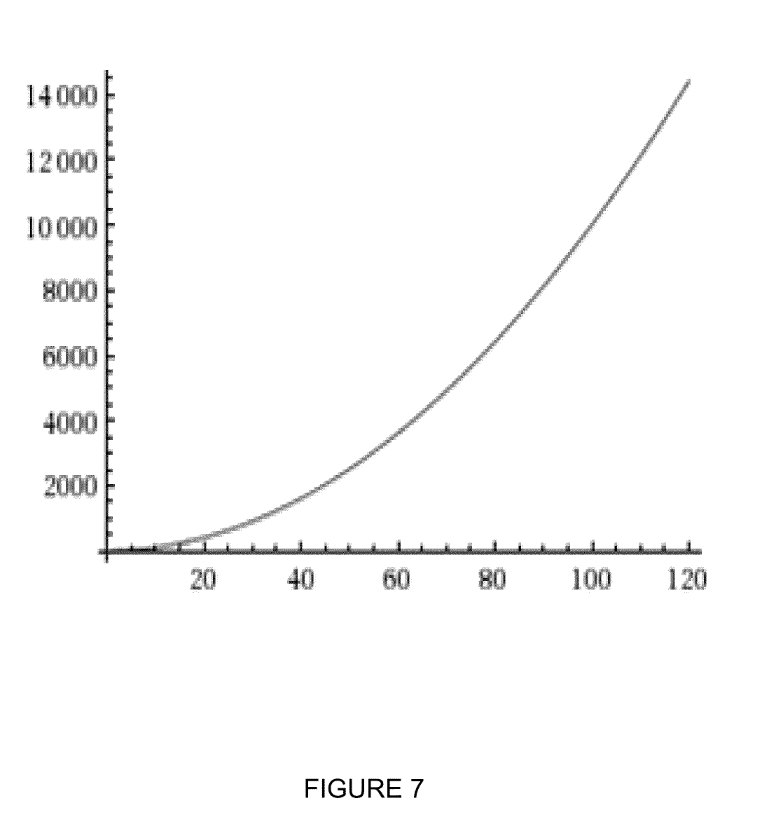

FIG. 7 is a plot that shows weighting applied to the sensed signal samples of FIG. 6, according to an embodiment. The weighting provides a multiplier for each of the sensed signal samples of, for example, FIG. 6. For this exemplary embodiment, the weighting includes a quadratic equation in which more recent samples are provided greater weighting. The Y-axis includes the 120 sampling times and the X-axis includes selected values of weightings for each of the selected values. For other embodiments, the weighting includes a linear function in which more recent samples are provided greater weighting. For other embodiments, the weighting includes constants in which more recent samples are provided the same weighting as older samples.

For at least some embodiments, different weighting functions are used to apply different time weightings. A high degree polynomial weighting function puts more weight on more recent data as opposed to older data. At least some embodiments, the effect of some atypical sensed data (for example a recent spike in activity that would cause the estimated occupants to increase unrealistically) are de-emphasized. That is, when an anomaly is detected (for example, activity sensed for a small number of sample that is substantially different than the majority of the samples) the samples associated with the anomaly are de-emphasized or ignored.

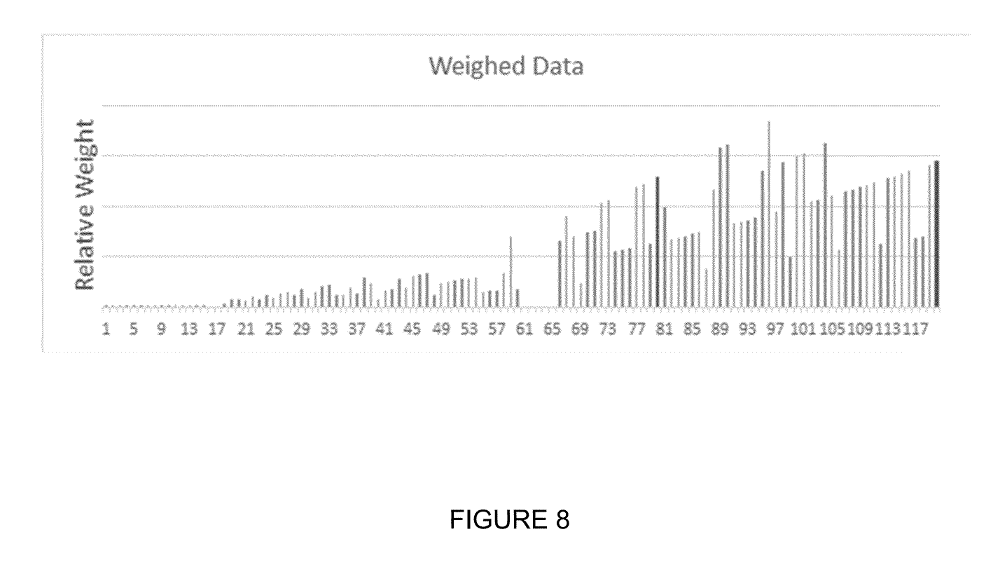

FIG. 8 is a plot that shows the sensed signal samples of FIG. 6 where the weighting of FIG. 7 has been applied to the sensed signal samples, according to an embodiment. Due to the quadratic weighting of FIG. 7, the more recent values are weighted more, and the plot of FIG. 8 reflects the greater weighting of the more recent samples.

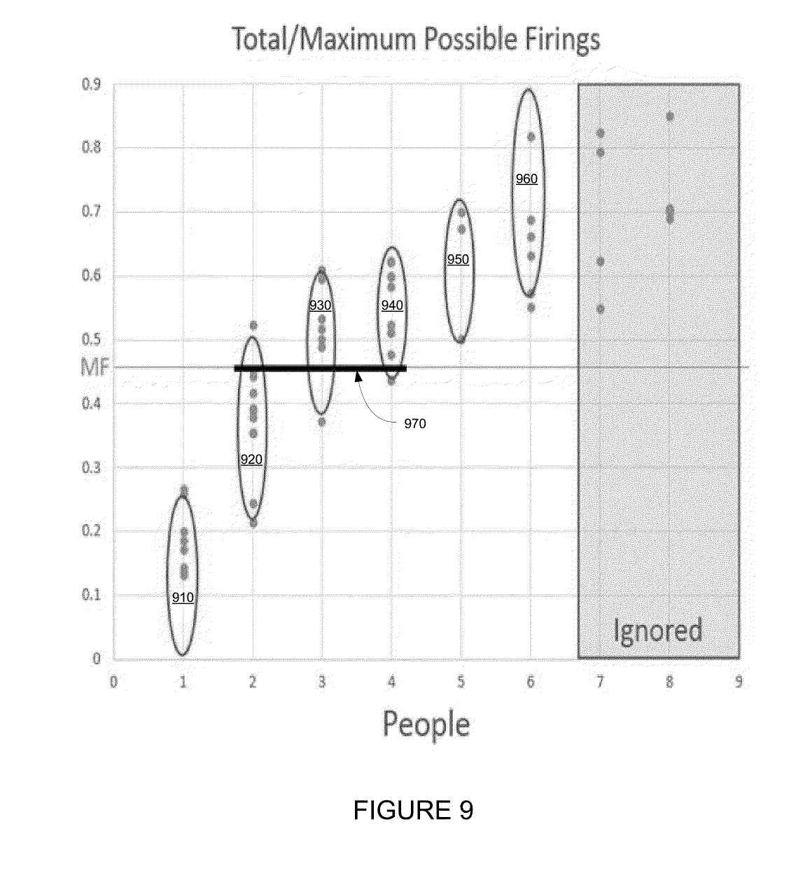

FIG. 9 shows a plot of weighted averages of the weighted sensed signal samples of FIG. 8 for an exemplary room, for multiple trials, according to an embodiment. That is, the room that includes some number of sensors is monitored over time using a selected motion sampling criteria while known numbers of occupants are within the room. The weighting plot of FIG. 8 or an equivalent weighting plot or an equivalent representation is generated. The weighting plot is then averaged to a single number, wherein if all of the sensors detect motion for all of the samples, the average is 1, and if none of the sensors detect motion for all the samples, the average is 0.

The indicated oval 910 includes the weighted averages generated for multiple trials utilizing a selected motion sampling criteria when the room under test is occupied by 1 person. As shown, each trial generates a weighted average. The oval encapsulates 90% of the trials with one occupant in the room. Further, ovals 920, 930, 940, 950, 960 provide similar ranges of weighted averages for 2, 3, 4, 5, 6 occupants within the room.

The line 970 shows that for an exemplary generated weighted average, the likelihood of how many occupants are within the room. As shown, for a weighted average of 0.46, collected data for 2, 3 or 4 occupants each indicate that 0.46 is encapsulated by each of their respective 90% certainty ranges.

It can be observed that by the analysis shown above in FIG. 9 that the certainty obtained is based on collected and pre-characterized data. For each number of occupants a number of samples are collected to encompass a variety of different activity levels. With this, for each quantity of occupants, and for each motion sampling criteria we derive a range that encompasses 90% of that collected average motion sampling criteria. Stated generically, the number of occupants and the confidence in that estimate is based at least in part upon a pre-characterization of that room or a similar type of room.

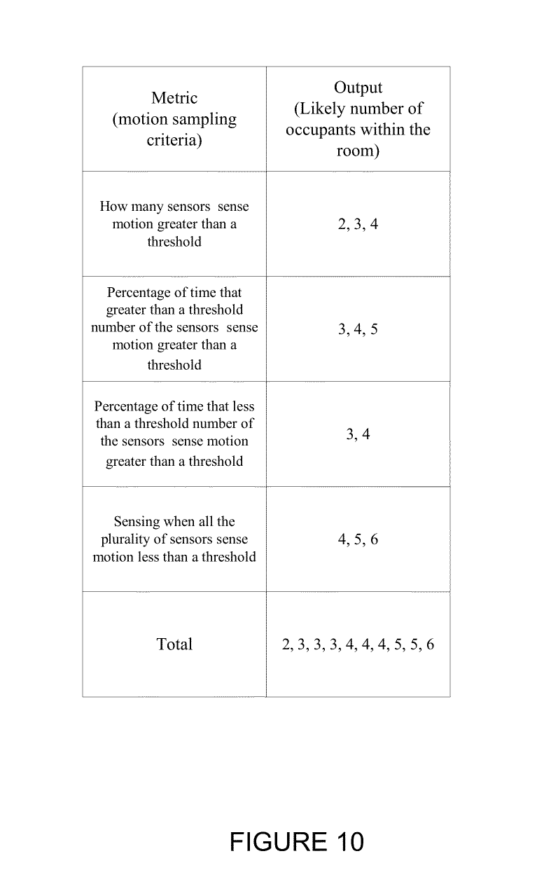

FIG. 10 is a table that shows estimated numbers of occupants while utilizing several different motion sampling criteria, according to an embodiment. A first motion sampling criteria includes a determination of how many sensors sense motion greater than a threshold for each sampling period. As described above, with quadratic weighting applied to the sensed signal samples, an estimate is that there is at least a 90% likelihood that there are 2, 3 or 4 occupants.

A second sampling criteria includes determination of percentage of time that greater than a threshold number of the sensors sense motion greater than a threshold for each sampling period. With a linear weighting applied to the sensed signals, an estimate is that there is at least a 90% likelihood that there are 3, 4, or 5 occupants.

A third sampling criteria includes determination of percentage of time that less than a threshold number of the sensors sense motion greater than a threshold for each sampling period. With a linear weighting applied to the sensed signals, an estimate is that there is at least a 90% likelihood that there are 3 or 4 occupants.

A fourth sampling criteria includes determination of when all the plurality of sensors sense motion less than a threshold for each sampling period. With a constant weighting applied to the sensed signals, an estimate is that there is at least a 90% likelihood that there are 4, 5 or 6 occupants.

Finally, results of all of the different sampling criteria can be summed, providing a summed result of 2, 3, 3, 3, 4, 4, 4, 5, 5, 6. That is, the total output has 10 entries, but only 5 distinct occupancies are represented. For an embodiment, the entries are gone through to determine a frequency of occurrence for each of them. In this example, the frequencies of occurrence are 2 occupants: 10%, 3 occupants: 30%, 4 occupants: 30%, 5 occupants: 20%, and 6 occupants: 10%. Further, for this embodiment, any occupancy that has a frequency lower than 15% (adjustable) is removed and the certainty of the estimate is reduced by its frequency. In this example occupancies of 2 and 6 are removed because they occur only 10% of the time. This leaves only 3, 4, and 5 and reduces the certainty to 80%. Therefore, the estimate of the number of occupants is: Occupancy=4±1 with 80% certainty.

It is to be understood that any number of exemplary sampling criteria can be utilized. Further, results of the different sampling criteria can be combined in different ways, and a weighting of each of the different sampling criteria can adaptively adjusted.

For an embodiment the weighting of the different motion sampling criteria are adaptively adjusted. For example, some motion sampling criteria are more accurate with a low number of occupants and some perform better with high numbers of occupants. Further, for example if the weighted average of a motion sampling criteria gives an estimate that contains 4 distinct occupancies and a different motion sampling criteria's estimate contains 2 distinct occupancies, the motion sampling criteria with 2 occupancies is more precise and should bear a higher weight.

Although specific embodiments have been described and illustrated, the described embodiments are not to be limited to the specific forms or arrangements of parts so described and illustrated. The embodiments are limited only by the appended claims.

What is claimed:

1. An occupancy detection system, comprising:
a plurality of sensors located within an area;
communication links between each of the sensors and a controller the controller operative to:
receive sense data from the plurality of sensors;
group the data according to identified groupings of the plurality of sensors;
sense occupancy within at least a portion of the area based on data analytics processing of one or more of the groups of sensed data.

2. The occupancy detection system of claim 1, wherein the data analytics processing comprises pattern recognition processing

3. The occupancy detection system of claim 1, wherein the controller is further operative to sense numbers of occupants within one or more of the groups based on the data analytics processing of the groups of sensed data.

4. The occupancy detection system of claim 1, wherein the controller is further operative to sense motion of the occupants within one or more of the groups based on the data analytics processing of the groups of sensed data.

5. The occupancy detection system of claim 1, wherein the controller is further operative to sense motion of the occupants across a plurality of the groups based on the data analytics processing of the groups of sensed data.

6. The occupancy detection system of claim 3, wherein at least a portion of the plurality of sensors comprises motion sensors and wherein sensing numbers of occupants within one or more of the groups based on the data analytics processing of the groups of sensed data comprises the controller being operative to:
group motion sensing data according to one or more identified rooms within the area;
perform the data analytics processing once every sampling period;
perform the data analytics processing on the motion sensing data to determine a number of occupants within the one or more identified rooms, and a level of certainty of the number of occupants.

7. The occupancy detection system of claim 6, wherein the controller is further operative to:
determine whether one or more of the identified rooms is vacant, possibly occupied, occupied, or possibly exited.

8. The occupancy detection system of claim 6, wherein performing the data analytics processing on the motion sensing data to estimate a number of occupants within the one or more identified rooms, and a level of certainty of the number of occupants, comprises:
select a motion sampling criteria;
generate a sample number for each sampling time over a sampling interval;
apply a time-weighting to the sample numbers over the sampling interval;
determine a weighted average by averaging the time-weighted sample numbers over the sampling period; and
estimate a number of occupants and a certainty of the number of occupants based the weighted average.

9. The occupancy detection system of claim 6, further comprising selecting a plurality motion sampling criteria, and combining estimated numbers of occupants of the plurality of motion sampling criteria to generate a combined motion sampling criteria estimate of the number of occupants and a certainty of the number of occupants.

10. The occupancy detection system of claim 6, wherein combining estimated numbers of occupants of the plurality of motion sampling criteria comprises weighting of different motion sampling criteria.

11. The occupancy detection system of claim 8, wherein motion sampling criteria comprises generating the sampling number based on sensing how many sensors of a plurality of sensors of the one or more identified rooms sense motion greater than a threshold at each sampling time of the sampling interval, and selecting a quadratic weighting to apply to the sample numbers over the sampling interval.

12. The occupancy detection system of claim 8, wherein motion sampling criteria comprises generating the sampling number based on sensing a percentage of time that greater than a threshold number of the sensors of a plurality of sensors of the one or more identified rooms sense motion greater than a threshold at each sampling time of the sampling interval, and selecting a linear weighting to apply to the sample numbers over the sampling interval.

13. The occupancy detection system of claim 8, wherein motion sampling criteria comprises generating the sampling number based on sensing a percentage of time that less than a threshold number of the sensors of a plurality of sensors of the one or more identified rooms sense motion greater than a threshold at each sampling time of the sampling interval, and selecting a linear weighting to apply to the sample numbers over the sampling interval.

14. The occupancy detection system of claim 8, wherein motion sampling criteria comprises generating the sampling number based on sensing when all the plurality of sensors of the one or more identified rooms sense motion less than a threshold at each sampling time of the sampling interval, and selecting a constant to apply to the sample numbers over the sampling interval.

15. The occupancy detection system of claim 6, wherein performing data analytics on the motion sensing data comprises the controller being operative to:
determine a percentage of time activity within the one or more determined rooms is detected.

16. The occupancy detection system of claim 6, wherein performing data analytics on the motion sensing data comprises the controller being operative to:
determine a quadratically weighted average of a number of the motion sensors within the one or more determined rooms that sense motion during a period of time.

17. The occupancy detection system of claim 6, wherein performing data analytics on the motion sensing data comprises the controller being operative to:
determine a linearly weighted percentage that a small threshold of the motion sensors within the one or more determined rooms that sense motion during a period of time.

18. The occupancy detection system of claim 6, wherein perform data analytics on the motion sensing data comprises the controller being operative to:
determine a linearly weighted percentage that a large threshold of the motion sensors within the one or more determined rooms that sense motion during a period of time.

19. A method of detecting occupancy, comprising:
receiving sense data from the plurality of sensors;
grouping the data according to identified groupings of the plurality of sensors;
sensing occupancy within at least a portion of the area based on data analytics processing of one or more of the groups of sensed data.

20. A method of detecting occupancy, comprising:
receiving motion sense data from a plurality of motion sensors;
grouping the motion sensing data according to one or more identified rooms;
performing data analytics processing on the motion sensing data to determine a number of occupants within the one or more identified rooms, and a level of certainty of the number of occupants.
